(19) United States
(12) Patent Application Publication
(10) Pub. No.: US 2003/0072324 A1
(43) Pub. Date: Apr. 17, 2003

(54) Traffic manipulation on a computer network - II

(76) Inventors: Andrew Franklin Seaborne, Bristol (GB); Christopher Tofts, Bristol (GB)

Correspondence Address: HEWLETT-PACKARD COMPANY, Intellectual Property Administration, P.O. Box 272400, Fort Collins, CO, 80527-2400, US

(21) Appl. No.: 10/267,633

(22) Filed: Oct. 9, 2002

(30) Foreign Application Priority Data
Oct. 11, 2001 (GB) 0124365.8

(51) Int. Cl. H04L 12/413

(52) U.S. Cl. 370/445; 370/252

(57) ABSTRACT

In order to improve throughput on a computer network 10, a traffic manipulation device 12 is used to exploit the collision properties on the computer network 10. Deliberate collisions of data packets are caused to manipulate traffic flow on the computer network 10.

### BACKGROUND OF THE INVENTION

This invention relates to a method of manipulating traffic on a computer network and to a computer network having traffic manipulation capabilities.

Data traffic on a computer network, which may typically use the TCP/IP protocol is structured. The structure arises on various timescales, such as a short timescale as a result of the TCP/IP ramp, on a medium timescale from bursts of sending complete documents, and a long term timescale as a result of the coupled nature of communications, e.g. from computer A to computer B, computer B to computer C, and computer C to computer A and so on, as in an Ethernet loop.

The basis of traffic transport on computer networks relies on data streams being uncorrelated and random. As set out above, this is not the case, because there is structure on various timescales.

An existing solution to this problem has been provided by the degree2 product (see for example www.degree2.com), which is a switch located at a local area network (LAN)/wide area network (WAN) interface. The switch uses queuing, rate limiting and traffic shaping mechanisms in order to manipulate traffic flow. The main intention of the degree2 product is to ensure WAN utilisation and fair resource allocation to network applications.

Problems arise with the previous solution in that it is expensive to implement.

### SUMMARY OF THE INVENTION

It is an object of the present invention to address the above mentioned disadvantages.

According to a first aspect of the present invention a method of manipulating traffic flow on a computer network comprises causing deliberate collisions between data packets on the computer network, in which he data packet collision are caused in order to seek to randomise the traffic on the computer network.

According to a second aspect of the present invention a method of manipulating traffic flow on a computer network comprises causing deliberate collisions between data packets on the computer network, in which the data packets for collision are introduced in order to cause the traffic to more closely conform to a negative exponential distribution.

According to a third aspect of the present invention a method of manipulating traffic flow on a computer network comprises causing deliberate collisions between data packets on the computer network, the data packet collisions are caused to seek to improve values of mean rate, standard distribution and/or Hurst parameter of data on the computer network

The data packet collisions are caused so that values of mean rate, standard distribution and/or Hurst parameter of data on the computer network conform more closely to those of a random distribution.

The collision of data packets may cause the packets to be lost, which may require packets to be re-sent.

The data packet collisions may be caused to increase throughput in the computer network.

The collision of data packets may be caused only with packets of a particular category of packet, preferably a control category.

A traffic manipulation device may introduce a data packet to collide with said control category packet, thereby causing the pattern of traffic to be changed, by the introduced packet and the control category packet being lost. The traffic manipulation device may have a connection to a local part of the computer network and/or a connection to a wide area network (WAN) or a WAN connection.

The use of collisions between data packets allows monitoring of the traffic on the computer network.

The computer network is preferably an Ethernet computer network, which may use a TCP/IP protocol.

The data packets for collision may be introduced in order to cause the traffic to more closely conform to an Erlang or hyperexponential distribution.

The data packet collisions may be caused to break up long bursts of packets, which may be from one computer, preferably to allow access to the network to other computers.

The data packet collisions may be caused to exploit existing back-off strategies used by the computer network, which strategies may include retry with fixed probability at each future instant, or may include retry with a geometrically shrinking probability after a collision.

The collision of data packets may be controlled by a software implemented controller, preferably implanted in one or more entities sharing the computer network.

According to a fourth aspect of the present invention a data traffic manipulation device for manipulating flow on a computer network includes data packet detection means and packet collision means operable to cause collisions between data packets on the computer network, in which data packet collisions are caused in order to seek to randomise the traffic flow on the computer network.

According to a fifth aspect of the present invention a data traffic manipulation device for manipulating flow on a computer network includes data packet detection means and packet collision means operable to cause collisions between data packets on the computer network, in which data packets for collision are introduced in order to cause the traffic flow to more closely conform to a negative exponential distribution.

According to a sixth aspect of the present invention a data traffic manipulation device for manipulating flow on a computer network includes data packet detection means and packet collision means operable to cause collisions between data packets on the computer network, in which data packet collisions are caused to seek to improve values of mean rate, standard deviation and/or Hurst parameter of the data flow on the computer network.

The data packet detection means may be a network card, which may be an Ethernet card. Preferably, the computer network is an Ethernet network. The data packet detection means may be operable to detect data packets of a control category.

The packet collision means may be operable to introduce data packets into the computer network to collide with data packets detected by the detection means.

The invention extends to a computer network including a plurality of computers and having a data traffic manipulation device according to the fourth, fifth or sixth aspects.

The invention extends to a recordable medium bearing a program operable to perform the method of the first, second or third aspects.

All of the features disclosed herein may be combined with any of the above aspects, in any combination.

### BRIEF DESCRIPTION OF THE DRAWINGS

Specific embodiments of the present invention will now be described, by way of example, and with reference to the accompanying drawings in which:

FIG. 1 is a schematic view showing a traffic manipulation device attached to a computer network; and

FIG. 2 is a schematic view of a second embodiment of traffic manipulation device attached to a computer network.

### DETAILED DESCRIPTION OF A PREFERRED EMBODIMENT

In order to improve throughput on a computer network 10, a traffic manipulator device 12 is used to exploit the collision properties of the computer network 10. On an Ethernet-based network (see IEEE Standard 802.3 for further information in relation to the Ethernet protocol) when two data packets collide, usually because of accidental simultaneous, or near simultaneous, sending of the packets, then both packets are lost and have to be retried. This property of an Ethernet network is exploited to kill the packet being sent. As data packets traverse the computer network 10 they can be examined in the usual way by an Ethernet card, which would normally examine packets to detect whether a packet is intended for that particular Ethernet card. If the examined packet falls into a control category then the traffic manipulation device 12 will perform deliberate collision with this packet. A control category is defined to include any packet that is deemed to be removable from the computer network, either a packet going to a wider network via a wide area network (WAN) connection 14 that will cause a traffic pattern violation to occur, or within a local network 16 if an attempt is being made to smooth the load on the computer network 10.

The collision caused by the traffic manipulation device 12 prevents the packet from being delivered and therefore causes the pattern of traffic on the computer network 10 to be changed. This change may occur by, for example, imposing packets at fixed intervals, which can lower the peak traffic rates from users of the computer network 10. For example, adding 10% fixed rate traffic can actually increase throughput in a shared TCP/IP system. Equally, by putting traffic into the computer network 10 with particular probabilistic properties throughput can be increased. Such probabilistic properties may include distribution of the added data as an exponential function, or a distribution chosen based on historic traffic patterns on the computer network 10. A suitable probabilistic test for providing randomness may be one of F, Z, Chi or G-Het distributions. Changing the traffic patterns in the computer network 10 may be desirable in order to achieve the deliberate randomisation of traffic. The reason for this is that current patterns of traffic within computer networks are particularly difficult to predict. However, random traffic is actually straightforward to predict.

Traffic patterns may also be changed to ensure that traffic that passes from the local network 16 to a wider network via the WAN connection 14 has specified values (or values in a specified range) of mean rate, standard deviation and a Hurst parameter (a measure of self-similarity). The standard deviation may be required to be close to the mean. Also, traffic passing via the WAN connection 14 should not exceed a band width limitation, which could be a maximum capacity of the outgoing WAN connection 14. Being an Ethernet to ISDN link the WAN connection would have a much smaller capacity than links within the local network 16. Alternatively, it may be that an agreement has been made with a supplier not to exceed 50% usage of the maximum capacity of a link to a wider network.

The data distribution may be changed to try and achieve a negative exponential distribution of data or failing that an Erlang or hyperexponential distribution.

Furthermore the traffic patterns may be advantageously changed by breaking long bursts of packets from a particular user to allow other users access to the computer network 10. A burst may be the size of a file, possibly up to 4GB. The length of a burst in time is file size divided by transmission rate.

Changing traffic patterns can be used to achieve fairness by exploiting back-off strategies, such as retrying with fixed probability at each future instant, or retrying with a geometrically shrinking probability after a collision (see the CIEE Standard referred to above).

Finally, patterns of traffic may be advantageously changed to give priority access to particular components of the computer network 10, such as any arbitrary specific place, or group of places on the network, which may be a particular set of users or a particular department within an institution, for example. A further example would be to ensure that traffic patterns reserve 50% of the computer capacity for a systems team by ensuring that all other machines 18 on the local network 16 spend most of their time in a backed-off state.

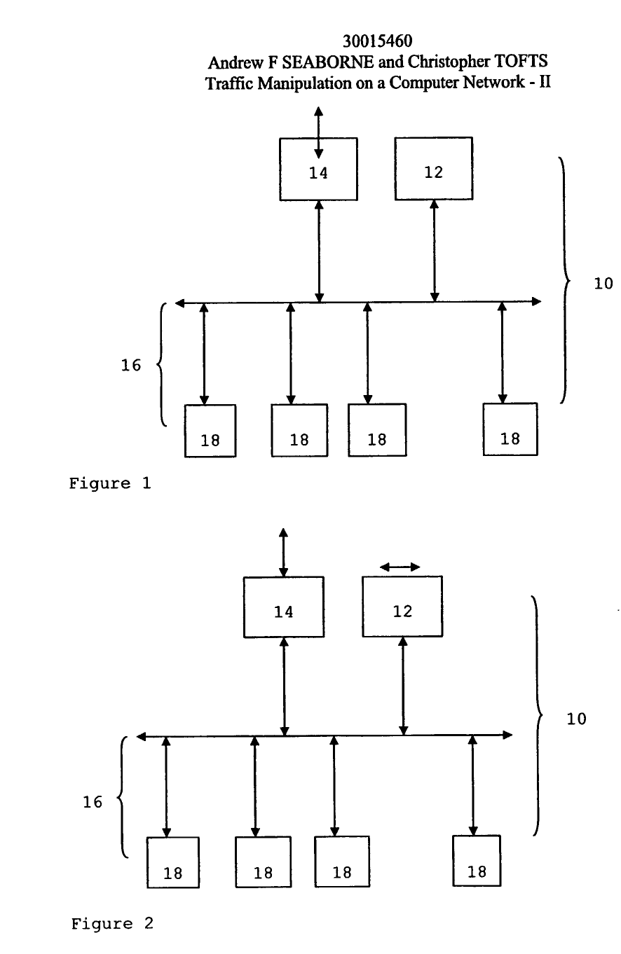

FIG. 2 shows an alternative set up to that shown in FIG. 1. Parts in FIG. 2 which are common to those in FIG. 1 are given the same reference numerals. In FIG. 2, the traffic manipulation device 12, as well as having an attachment to the local network 16 also has a connection to the WAN connection 14. This allows the traffic manipulation device 12 to observe the state of the WAN connection 14. Information gathered from the WAN connection 14 can be used to produce more subtle traffic control. Such control may be to detect the onset of outgoing traffic having “poor” properties of mean rate, standard deviation Hurst parameter, and then initiating a response to control that poor pattern. Also, it would be possible to block specific senders known to generate poor traffic. In this way, rather than observing all of the packets all of the time it would be possible to wait until potential problems are observed by the traffic manipulation device 12 with the outgoing link, the WAN connection 14, and subsequently manipulate the internal traffic on the local network 16.

The embodiments described above provide a solution to the problem of traffic manipulation on a computer network which takes advantage of the properties of the local network 16 and gives a considerably cheaper implementation than the prior art solutions described above. Dealing with traffic at the level of the local network 16 gives greater flexibility of control. Also, the solution disclosed does not require that any of the current elements within a network, such as the computers 18 are changed. Instead, retry properties of the network 10 are exploited. In particular, the properties can be exploited to give predictable performance within a data centre without changing any of the other components of the hardware or software.

The traffic manipulation device 12 may also be implemented in software added to one or more of the computers 18 showing the computer network 10.

1. A method of manipulating traffic flow on a computer network comprises causing deliberate collisions between data packets on the computer network, in which the data packet collisions are caused in order to seek to randomise the traffic flow on the computer network.

2. A method of manipulating traffic flow on a computer network comprises causing deliberate collisions between data packets on the computer network, in which the data packets for collision are introduced in order to cause the traffic flow to more closely conform to a negative exponential distribution.

3. A method of manipulating traffic flow on a computer network comprises causing deliberate collisions between data packets on the computer network, in which the data packet collisions are caused to seek to improve values of mean rate, standard deviation and/or Hurst parameter of the data flow on the computer network.

4. A method as claimed in claim 1, in which the collision of data packets causes the packets to be lost.

5. A method as claimed in claim 1, in which the data packet collisions are caused to increase throughput in the computer network.

6. A method as claimed in claim 1, in which the collision of data packets is caused only with packets of a particular category of packet.

7. A method as claimed in claim 6, in which a traffic manipulation device introduces a data packet to collide with said particular category of packet.

8. A method as claimed in claim 7, in which the traffic manipulation device has a connection to a local part of the computer network and/or a connection to a wide area network (WAN).

9. A method as claimed in claim 1, in which the use of collisions between data packets allows monitoring of the traffic on the computer network.

10. A method as claimed in claim 1, in which the computer network is an Ethernet computer network.

11. A method as claimed in claim 1, in which the data packet collisions are caused to break up long bursts of packets.

12. A method as claimed in claim 1, in which the data packet collisions are caused to exploit existing back-off strategies used by the computer network.

13. A method as claimed in claim 1, in which the collision of data packets is controlled by a software implemented controller.

14. A data traffic manipulation device for manipulating flow on a computer network includes data packet detection means and packet collision means operable to cause collisions between data packets on the computer network, in which data packet collisions are caused in order to seek to randomise the traffic flow on the computer network.

15. A data traffic manipulation device for manipulating flow on a computer network includes data packet detection means and packet collision means operable to cause collisions between data packets on the computer network, in which data packets for collision are introduced in order to cause the traffic flow to more closely conform to a negative exponential distribution.

16. A data traffic manipulation device for manipulating flow on a computer network includes data packet detection means and packet collision means operable to cause collisions between data packets on the computer network, in which data packet collisions are caused to seek to improve values of mean rate, standard deviation and/or Hurst parameter of the data flow on the computer network.

17. A data traffic manipulation device as claimed in claim 14, in which the data packet detection means is a network card.

18. A data traffic manipulation device as claimed in claim 14, in which the packet collision means are operable to introduce data packets into the computer network to collide with data packets detected by the detection means.

19. A computer network includes a data traffic manipulation device according to claim 14 and a plurality of computers.

20. A recordable medium bearing a program operable to perform the method of claim 1.

21. A recordable medium bearing a program operable to perform the method of claim 2.

22. A recordable medium bearing a program operable to perform the method of claim 3.
